(19) United States
(12) Patent Application Publication
(10) Pub. No.: US 2026/0313723 A1
(43) Pub. Date: Oct. 8, 2026

(54) COMMUNICATION OVER UNDERLAY NETWORK

(71) Applicant: LG ELECTRONICS INC., Seoul (KR)

(72) Inventors: Myungjune YOUN, Seoul (KR); Hyunsook KIM, Seoul (KR); Laeyoung KIM, Seoul (KR)

(73) Assignee: LG ELECTRONICS INC., Seoul (KR)

(21) Appl. No.: 19/478,766

(22) PCT Filed: Apr. 15, 2024
(86) PCT No.: PCT/KR2024/095722

§ 371 Date: Oct. 24, 2025

Related U.S. Application Data
(60) Provisional application No. 63/463,900, filed on May 4, 2023.

(51) Int. Cl. H04W 76/12; H04W 28/02; H04W 48/18; H04W 84/04

(52) U.S. Cl. CPC H04W 76/12; H04W 28/0215; H04W 48/18; H04W 84/042

(57) ABSTRACT

A disclosure of the present specification provides a method by which a UE performs communication. The method comprises the steps of: transmitting a registration request message to a PLMN; on the basis of the registration request message, receiving service information from a specific network node of the PLMN; and on the basis of the service information, establishing a PDU session with the PLMN through an underlay network, wherein the registration request message includes capability information, the capability information includes information indicating that the UE supports information regarding an available service based on the underlay network, the service information includes information indicating that a first service is available on the basis that the underlay network is a first network, and on the basis that the underlay network is the first network, the PDU session is for the first service.

### CROSS-REFERENCE TO RELATED APPLICATION(S)

This application is the National Stage filing under 35 U.S.C. 371 of International Application No. PCT/KR2024/095722, filed on Apr. 15, 2024, which claims the benefit of U.S. Provisional Application No. 63/463,900, filed on May 4, 2023, the contents of which are all incorporated by reference herein in their entirety.

### TECHNICAL FIELD

The present specification relates to mobile communications.

### BACKGROUND ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

If a terminal receives a service from an overlay network that is not provided by the underlay network, the QoS of that service may be lowered.

### SUMMARY

Information about available services for each underlay network is provided to the terminal.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIG. 4 is a block diagram of a next generation cellular network.

FIG. 5 illustrates an example 5G system structure to which an implementation of the present specification may be applied.

FIGS. 6 and 7 show an example of a registration procedure to which implementations of the present disclosure is applied.

FIGS. 8 and 9 show an example of a PDU session establishment procedure to which implementations of the present disclosure is applied.

FIG. 10 shows an example of accessing a PLMN service via an SNPN.

FIG. 11 shows an example of accessing SNPN services via a PLMN.

FIGS. 12 and 13 show examples of procedures according to embodiments of the present disclosure.

FIG. 14 shows the procedure of the UE according to disclosure of the present specification.

FIG. 15 shows the procedure of the PLMN according to disclosure of the present specification.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

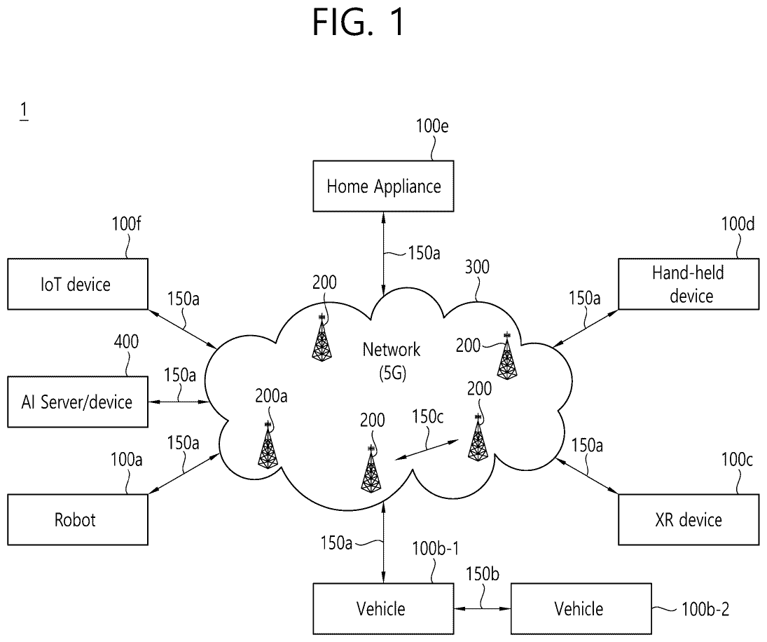

FIG. 1 Shows an Example of a Communication System to which Implementations of the Present Disclosure is Applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

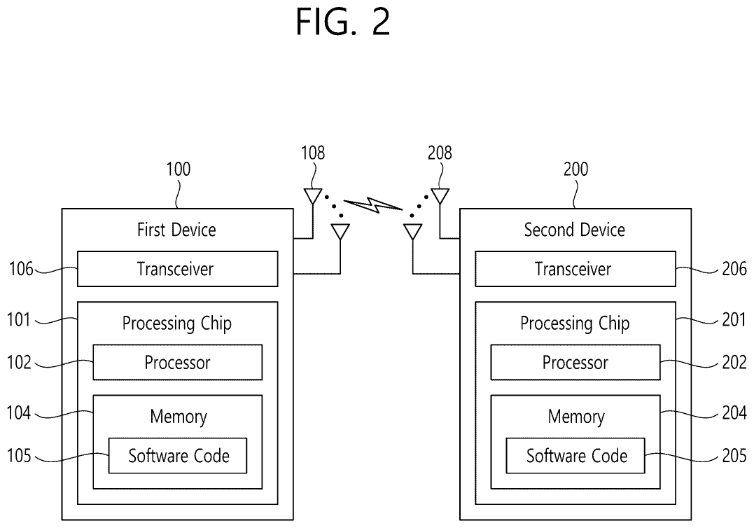

FIG. 2 Shows an Example of Wireless Devices to which Implementations of the Present Disclosure is Applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104, 204 may be associated with the one or more processors 102, 202 and may store various forms of data, signals, messages, information, programs, codes, instructions, and/or commands. The one or more memories 104, 204 may comprise random access memory (RAM), dynamic RAM (DRAM), read-only memory (ROM), erasable programmable ROM (EPROM), flash memory, volatile memory, non-volatile memory, hard drives, registers, cache memory, computer-readable storage media, and/or combinations thereof. The one or more memories 104, 204 may be located inside and/or outside of the one or more processors 102, 202. Further, the one or more memories 104, 204 may be coupled to the one or more processors 102, 202 via various technologies, such as wired or wireless connections.

The one or more transceivers 106, 206 may transmit user data, control information, wireless signals/channels, etc. referred to in the descriptions, features, procedures, suggestions, methods, and/or flowcharts of operation disclosed herein to one or more other devices. The one or more transceivers 106, 206 may receive user data, control information, wireless signals/channels, etc. referred to in the descriptions, features, procedures, suggestions, methods, and/or flowcharts of operation disclosed herein from one or more other devices. For example, the one or more transceivers 106, 206 may be associated with the one or more processors 102, 202 and may transmit and receive wireless signals. For example, the one or more processors 102, 202 may control the one or more transceivers 106, 206 to transmit user data, control information, wireless signals, etc. to one or more other devices. Further, the one or more processors 102, 202 may control the one or more transceivers 106, 206 to receive user data, control information, wireless signals, etc. from the one or more other devices.

The one or more transceivers 106, 206 may be associated with one or more antennas 108, 208. Additionally and/or alternatively, the one or more transceivers 106, 206 may include one or more antennas 108, 208. The one or more transceivers 106, 206 may be configured to transmit and receive, via the one or more antennas 108, 208, user data, control information, wireless signals/channels, etc. referred to in the descriptions, features, procedures, suggestions, methods, and/or flowcharts of operation disclosed herein. As used herein, the one or more antennas 108, 208 may be a plurality of physical antennas, or a plurality of logical antennas (e.g., antenna ports).

The one or more transceivers 106, 206 may convert the received user data, control information, radio signals/channels, etc. from RF band signals to baseband signals in order to process the received user data, control information, radio signals/channels, etc. using the one or more processors 102, 202. The one or more transceivers 106, 206 may convert the processed user data, control information, radio signals/channels, etc. from baseband signals to RF band signals using the one or more processors 102, 202. To do so, the one or more transceivers 106, 206 may include (analog) oscillators and/or filters. For example, the one or more transceivers 106, 206 may up-convert an OFDM baseband signal to an OFDM signal via an (analog) oscillator and/or filter under the control of the one or more processors 102, 202, and transmit the up-converted OFDM signal at the carrier frequency. The one or more transceivers 106, 206 may receive the OFDM signal at the carrier frequency and, under the control of the one or more processors 102, 202, down-convert the OFDM signal to an OFDM baseband signal via an (analog) oscillator and/or filter.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

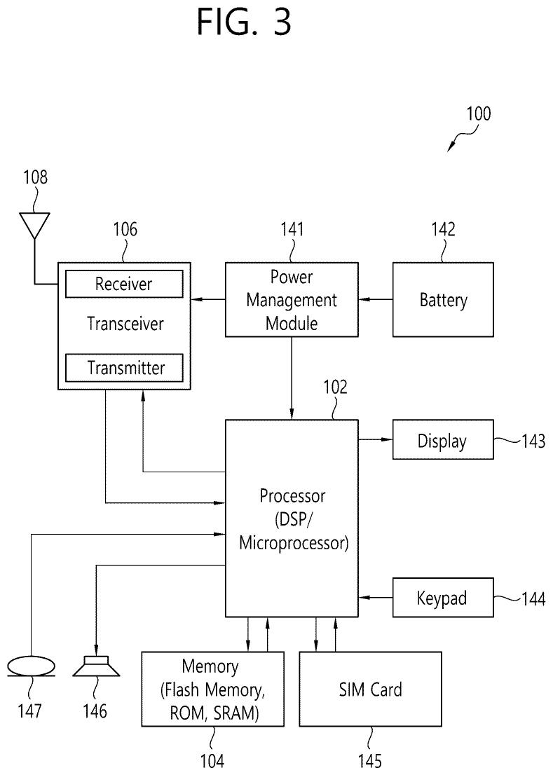

FIG. 3 Shows an Example of UE to which Implementations of the Present Disclosure is Applied.

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

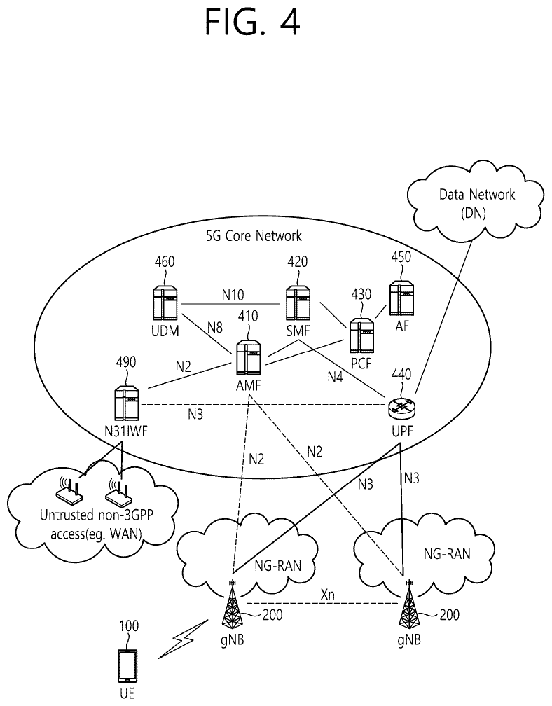

### FIG. 4 is a Block Diagram of a Next Generation Cellular Network.

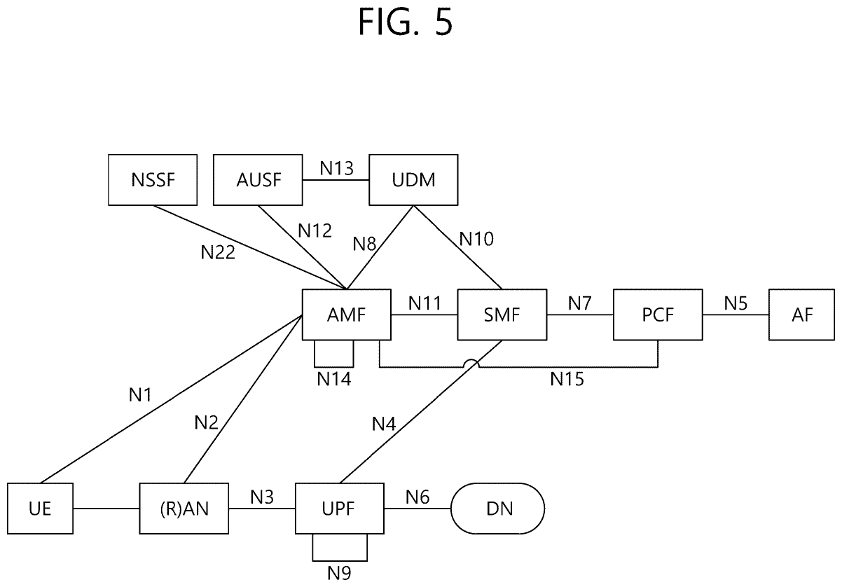

The 5G Core (5GC) may include a variety of components, some of which are shown in FIG. 5, such as the Access and Mobility Management Function (AMF) (410), the Session Management Function (SMF) (420), the Policy Control Function (PCF) (430), the User Plane Function (UPF) (440), the Application Function (AF) (450), the UDF (UDF) (450), and the UDF (UDF) (450): Policy Control Function (PCF) (430), User Plane Function (UPF) (440), Application Function (AF) (450), Unified Data Management (UDM) (460), and Non-3rd Generation Partnership Project (3GPP) Inter Working Function (N3IWF) (490).

The UE 100 is connected to the data network via the UPF 440 through a next generation radio access network (NG-RAN) including the gNB 20.

The UE 100 may also be provided data services via untrusted non-3GPP access, such as a wireless local area network (WLAN). To connect said non-3GPP access to the core network, a N3IWF 490 may be deployed.

The illustrated N3IWF 490 performs the function of managing the interworking between the non-3GPP access and the 5G system. When the UE 100 is associated with a non-3GPP access (e.g., WiFi, also referred to as IEEE 801.11), the UE 100 may be associated with the 5G system via the N3IWF 490. The N3IWF 490 communicates with the AMF 410 for control signaling and with the UPF 440 via the N3 interface for data transfer.

The illustrated AMF 410 may manage access and mobility in a 5G system. The AMF 410 may perform functions to manage Non-Access Stratum (NAS) security. The AMF 410 may perform functions to handle mobility in an idle state.

The UPF 440 shown is a type of gateway through which user data is transmitted and received. The UPF node 440 may perform all or part of the user plane functions of the Serving Gateway (S-GW) and Packet Data Network Gateway (P-GW) of fourth generation mobile communications.

The UPF 440 acts as a demarcation point between the next generation radio access network (NG-RAN) and the core network, and is the element that maintains the data path between the gNB 20 and the SMF 420. Additionally, the UPF 440 acts as a mobility anchor point when the UE 100 moves across the area served by the gNB 20. The UPF 440 may perform functions to handle PDUs. For mobility within the NG-RAN (Next Generation-Radio Access Network as defined in 3GPP Release-15 and later), the UPF may route packets. The UPF 440 may also function as an anchor point for mobility with other 3GPP networks (RANs defined prior to 3GPP Release-15, e.g., UTRAN, E-UTRAN (Evolved-UMTS (Universal Mobile Telecommunications System) Terrestrial Radio Access Network), or GERAN (Global System for Mobile Communication (GSM)/EDGE (Enhanced Data rates for Global Evolution) Radio Access Network). The UPF 440 may correspond to a termination point of the data interface to the data network.

The PCF 430 shown is a node that controls the operator's policies.

The AF 450 shown is a server for providing multiple services to the UE 100.

The UDM 460 shown is a type of server that manages subscriber information, such as a home subscriber server (HSS) in fourth generation mobile communications. The UDM 460 stores and manages subscriber information in a unified data repository (UDR).

The SMF 420 shown may perform the function of assigning an Internet Protocol (IP) address of a UE. The SMF 420 may also control protocol data unit (PDU) sessions.

As a point of reference, the drawing symbols for AMF 410, SMF 420, PCF 430, UPF 440, AF 450, UDM 460, N3IWF 490, gNB 20, or UE 100 may be omitted herein.

Fifth generation mobile communications supports multiple numerologies or subcarrier spacings (SCS) to support various 5G services. For example, an SCS of 15 kHz supports wide area coverage in traditional cellular bands; an SCS of 30 kHz/60 kHz supports dense-urban, lower latency, and wider carrier bandwidth; and an SCS of 60 kHz or higher supports bandwidths greater than 24.25 GHz to overcome phase noise.

FIG. 5 Illustrates an Example 5G System Structure to which an Implementation of the Present Specification May be Applied.

The 5G system (5GS; 5G system) structure consists of the following network functions (NFs).
AUSF (Authentication Server Function)
AMF (Access and Mobility Management Function)
DN (Data Network), e.g., operator services, internet access or third-party services
USDF (Unstructured Data Storage Function)
NEF (Network Exposure Function)
I-NEF (Intermediate NEF)
NRF (Network Repository Function)
NSSF (Network Slice Selection Function)
PCF (Policy Control Function)
SMF (Session Management Function)
UDM (Unified Data Management)
UDR (Unified Data Repository)
UPF (User Plane Function)
UCMF (UE radio Capability Management Function)
AF (Application Function)
UE (User Equipment)
(R)AN ((Radio) Access Network)
5G-EIR (5G-Equipment Identity Register)
NWDAF (Network Data Analytics Function)
CHF (Charging Function)
In addition, the following network functions may be considered.
N3IWF (Non-3GPP InterWorking Function)
TNGF (Trusted Non-3GPP Gateway Function)
W-AGF (Wireline Access Gateway Function)

FIG. 5 shows the 5G system structure of a non-roaming case using a reference point representation that shows how various network functions interact with each other.

In FIG. 5, UDSF, NEF and NRF are not described for clarity of the point-to-point diagram. However, all network functions shown may interact with UDSF, UDR, NEF and NRF as needed.

For clarity, the connection between the UDR and other NFs (e.g., PCFs) is not shown in FIG. 5. For clarity, the connection between NWDAF and other NFs (e.g. PCFs) is not shown in FIG. 5.

The 5G system architecture includes the following reference points.
N1: the reference point between the UE and the AMF.
N2: reference point between (R)AN and AMF.
N3: Reference point between (R)AN and UPF.
N4: reference point between SMF and UPF.
N6: Reference point between UPF and data network.
N9: reference point between two UPFs.

The following reference points show the interactions that exist between NF services in NF.
N5: Reference point between PCF and AF.
N7: reference point between SMF and PCF.
N8: reference point between UDM and AMF.
N10: reference point between UDM and SMF.
N11: reference point between AMF and SMF.
N12: reference point between AMF and AUSF.
N13: reference point between UDM and AUSF.
N14: reference point between two AMFs.
N15: Reference point between PCF and AMF in case of non-roaming scenario, and reference point between PCF and AMF of visited network in case of roaming scenario.
N16: reference point between two SMFs (in case of roaming, between the SMF of the visited network and the SMF of the home network)
N22: reference point between AMF and NSSF.

In some cases, it may be necessary to connect two NFs to each other to service the UE.

### <Registration Procedure>

A registration procedure is described. Section 4.2.2.2 of 3GPP TS 23.502 V16.3.0 (2019-12) can be referred.

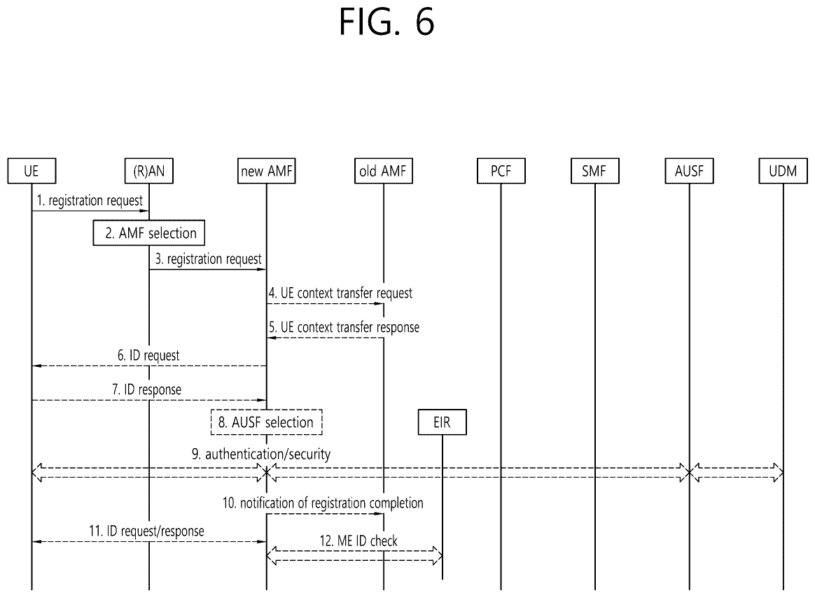

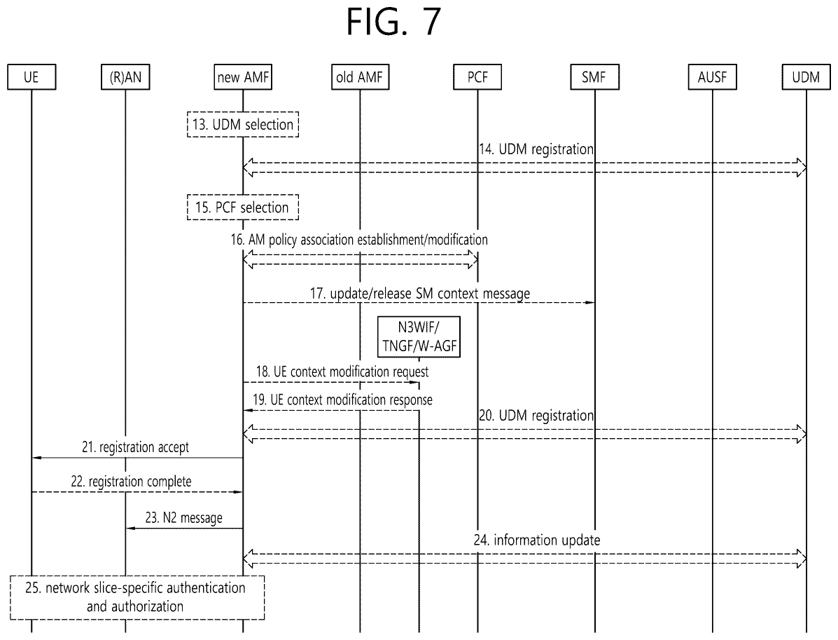

FIGS. 6 and 7 Show an Example of a Registration Procedure to which Implementations of the Present Disclosure is Applied.

A UE needs to register with the network to get authorized to receive services, to enable mobility tracking and to enable reachability. The UE initiates the registration procedure using one of the following registration types:
Initial registration to the 5GS; or
Mobility registration update; or
Periodic registration update; or
Emergency registration.

The general registration procedure in FIGS. 6 and 7 applies on all these registration procedures, but the periodic registration update need not include all parameters that are used in other registration cases.

The general registration procedure in FIGS. 6 and 7 is also used for the case of registration in 3GPP access when the UE is already registered in a non-3GPP access, and vice versa. Registration in 3GPP access when the UE is already registered in a non-3GPP access scenario may require an AMF change.

First, procedures of FIG. 6 are described.

(1) Step 1: The UE transmits a Registration Request message to the (R)AN. The Registration Request message corresponds to AN message.

The Registration Request message may include AN parameters. In the case of NG-RAN, the AN parameters include, e.g., 5G SAE temporary mobile subscriber identity (5G-S-TMSI) or globally unique AMF ID (GUAMI), the selected public land mobile network (PLMN) ID (or PLMN ID and network identifier (NID)) and Requested network slice selection assistance information (NSSAI). The AN parameters also include establishment cause. The establishment cause provides the reason for requesting the establishment of an RRC connection. Whether and how the UE includes the Requested NSSAI as part of the AN parameters is dependent on the value of the access stratum connection establishment NSSAI inclusion mode parameter.

The Registration Request message may include a registration type. The registration type indicates if the UE wants to perform an initial registration (i.e., the UE is in RM-DEREGISTERED state), a mobility registration update (i.e., the UE is in RM-REGISTERED state and initiates a registration procedure due to mobility or due to the UE needs to update its capabilities or protocol parameters, or to request a change of the set of network slices it is allowed to use), a periodic registration update (i.e., the UE is in RM-REGISTERED state and initiates a registration procedure due to the periodic registration update timer expiry) or an emergency registration (i.e., the UE is in limited service state).

When the UE is performing an initial registration, the UE shall indicate its UE identity in the Registration Request message as follows, listed in decreasing order of preference:
i) a 5G globally unique temporary identifier (5G-GUTI) mapped from an evolved packet system (EPS) GUTI, if the UE has a valid EPS GUTI.
ii) a native 5G-GUTI assigned by the PLMN to which the UE is attempting to register, if available;
iii) a native 5G-GUTI assigned by an equivalent PLMN to the PLMN to which the UE is attempting to register, if available;
iv) a native 5G-GUTI assigned by any other PLMN, if available.
v) Otherwise, the UE shall include its subscriber concealed identifier (SUCI) in the Registration Request message.

When the UE performing an initial registration has both a valid EPS GUTI and a native 5G-GUTI, the UE shall also indicate the native 5G-GUTI as additional GUTI. If more than one native 5G-GUTIs are available, the UE shall select the 5G-GUTI in decreasing order of preference among items (ii)-(iv) in the list above.

When the UE is performing an initial registration with a native 5G-GUTI, then the UE shall indicate the related GUAMI information in the AN parameters. When the UE is performing an initial registration with its SUCI, the UE shall not indicate any GUAMI information in the AN parameters.

For an emergency registration, the SUCI shall be included if the UE does not have a valid 5G-GUTI available; the permanent equipment identifier (PEI) shall be included when the UE has no subscriber permanent identifier (SUPI) and no valid 5G-GUTI. In other cases, the 5G-GUTI is included and it indicates the last serving AMF.

The Registration Request message may also include security parameters, PDU Session Status, etc. The security parameters are used for authentication and integrity protection. The PDU Session Status indicates the previously established PDU sessions in the UE. When the UE is connected to the two AMFs belonging to different PLMN via 3GPP access and non-3GPP access then the PDU Session status indicates the established PDU Session of the current PLMN in the UE.

(2) Step 2: The (R)AN selects an AMF.

If a 5G-S-TMSI or GUAMI is not included or the 5G-S-TMSI or GUAMI does not indicate a valid AMF, the (R)AN, based on (R)AT and requested NSSAI, if available, selects an AMF.

If UE is in CM-CONNECTED state, the (R)AN can forward the Registration Request message to the AMF based on the N2 connection of the UE.

If the (R)AN cannot select an appropriate AMF, it forwards the Registration Request message to an AMF which has been configured, in the (R)AN, to perform AMF selection.

(3) Step 3: The (R)AN transmits a Registration Request message to the new AMF. The Registration Request message corresponds to N2 message.

The Registration Request message may include whole information and/or a part of information included in the Registration Request message received from the UE which is described in step 1.

The Registration Request message may include N2 parameters. When NG-RAN is used, the N2 parameters include the selected PLMN ID (or PLMN ID and NID), location information and cell identity related to the cell in which the UE is camping, UE context request which indicates that a UE context including security information needs to be setup at the NG-RAN. When NG-RAN is used, the N2 parameters shall also include the establishment cause.

If the Registration type indicated by the UE is Periodic Registration Update, then steps 4 to 19 may be omitted.

(4) Step 4: If the UE's 5G-GUTI was included in the Registration Request message and the serving AMF has changed since last registration procedure, the new AMF may invoke the Namf_Communication_UEContextTransfer service operation on the old AMF including the complete registration request non-access stratum (NAS) message to request the UE's SUPI and UE context.

(5) Step 5: The Old AMF may respond to the new AMF for the Namf_Communication_UEContextTransfer invocation by including the UE's SUPI and UE context.

(6) Step 6: If the SUCI is not provided by the UE nor retrieved from the old AMF, the identity request procedure may be initiated by the new AMF sending the Identity Request message to the UE requesting the SUCI.

(7) Step 7: The UE may respond with an Identity Response message including the SUCI. The UE derives the SUCI by using the provisioned public key of the home PLMN (HPLMN).

(8) Step 8: The new AMF may decide to initiate UE authentication by invoking an AUSF. In that case, the new AMF selects an AUSF based on SUPI or SUCI.

(9) Step 9: Authentication/security may be established by the UE, new AMF, AUSF and/or UDM.

(10) Step 10: If the AMF has changed, the new AMF may notify the old AMF that the registration of the UE in the new AMF is completed by invoking the Namf_Communication_RegistrationCompleteNotify service operation. If the authentication/security procedure fails, then the registration shall be rejected, and the new AMF may invoke the Namf_Communication_RegistrationCompleteNotify service operation with a reject indication reason code towards the old AMF. The old AMF may continue as if the UE context transfer service operation was never received.

(11) Step 11: If the PEI was not provided by the UE nor retrieved from the old AMF, the Identity Request procedure may be initiated by the new AMF sending an Identity Request message to the UE to retrieve the PEI. The PEI shall be transferred encrypted unless the UE performs emergency registration and cannot be authenticated.

(12) Step 12: Optionally, the new AMF may initiate ME identity check by invoking the N5g-eir_EquipmentIdentityCheck_Get service operation.

Now, procedures of FIG. 7, which follow the procedures of FIG. 6, are described.

(13) Step 13: If step 14 below is to be performed, the new AMF, based on the SUPI, may select a UDM, then UDM may select a UDR instance.

(14) Step 14: The new AMF may register with the UDM.

(15) Step 15: The new AMF may select a PCF.

(16) Step 16: The new AMF may optionally perform an AM Policy Association Establishment/Modification.

(17) Step 17: The new AMF may transmit Update/Release SM Context message (e.g., Nsmf_PDUSession_UpdateSMContext and/or Nsmf_PDUSession_ReleaseSMContext) to the SMF.

(18) Step 18: If the new AMF and the old AMF are in the same PLMN, the new AMF may send a UE Context Modification Request to the N3IWF/TNGF/W-AGF.

(19) Step 19: The N3IWF/TNGF/W-AGF may send a UE Context Modification Response to the new AMF.

(20) Step 20: After the new AMF receives the response message from the N3IWF/TNGF/W-AGF in step 19, the new AMF may register with the UDM.

(21) Step 21: The new AMF transmits a Registration Accept message to the UE.

The new AMF sends a Registration Accept message to the UE indicating that the Registration Request has been accepted. 5G-GUTI is included if the new AMF allocates a new 5G-GUTI. If the UE is already in RM-REGISTERED state via another access in the same PLMN, the UE shall use the 5G-GUTI received in the Registration Accept message for both registrations. If no 5G-GUTI is included in the Registration Accept message, then the UE uses the 5G-GUTI assigned for the existing registration also for the new registration. If the new AMF allocates a new registration area, it shall send the registration area to the UE via Registration Accept message. If there is no registration area included in the Registration Accept message, the UE shall consider the old registration area as valid. Mobility Restrictions is included in case mobility restrictions applies for the UE and registration type is not emergency registration. The new AMF indicates the established PDU sessions to the UE in the PDU Session status. The UE removes locally any internal resources related to PDU sessions that are not marked as established in the received PDU Session status. When the UE is connected to the two AMFs belonging to different PLMN via 3GPP access and non-3GPP access then the UE removes locally any internal resources related to the PDU session of the current PLMN that are not marked as established in received PDU Session status. If the PDU Session status information was in the Registration Request message, the new AMF shall indicate the PDU Session status to the UE.

The Allowed NSSAI provided in the Registration Accept message is valid in the registration area and it applies for all the PLMNs which have their tracking areas included in the registration area. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the serving PLMN to the HPLMN S-NSSAIs.

Furthermore, optionally the new AMF performs a UE Policy Association Establishment.

(22) Step 22: The UE may send a Registration Complete message to the new AMF when it has successfully updated itself.

The UE may send a Registration Complete message to the new AMF to acknowledge if a new 5G-GUTI was assigned.

(23) Step 23: For registration over 3GPP Access, if the new AMF does not release the signaling connection, the new AMF may send the RRC Inactive Assistance Information to the NG-RAN. For registration over non-3GPP Access, if the UE is also in CM-CONNECTED state on 3GPP access, the new AMF may send the RRC Inactive Assistance Information to the NG-RAN.

(24) Step 24: The new AMF may perform information update towards the UDM.

(25) Step 25: The UE may execute Network Slice-Specific Authentication and Authorization procedure.

### <PDU Session Establishment Procedure>

A PDU session establishment procedure is described. Section 4.3.2 of 3GPP TS 23.502 V16.3.0 (2019-12) can be referred.

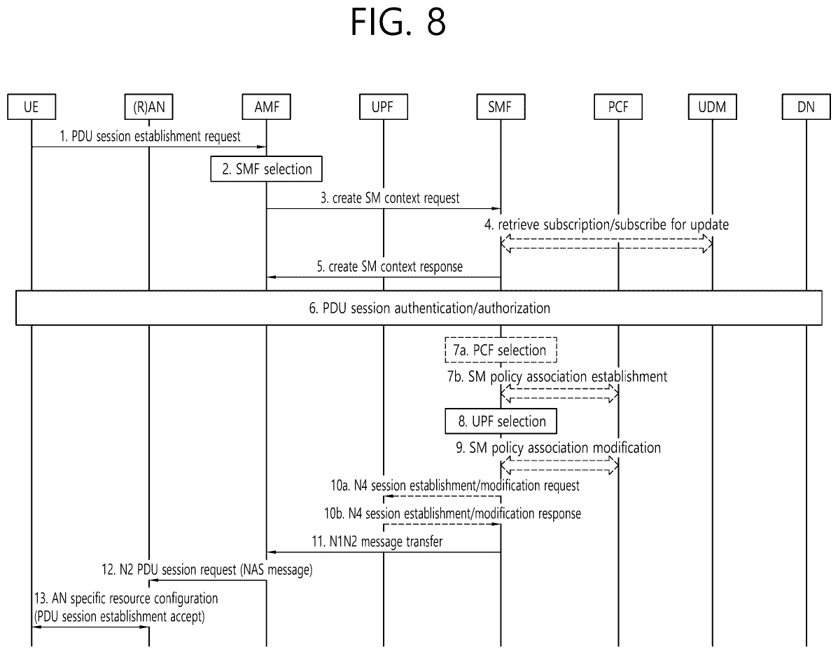

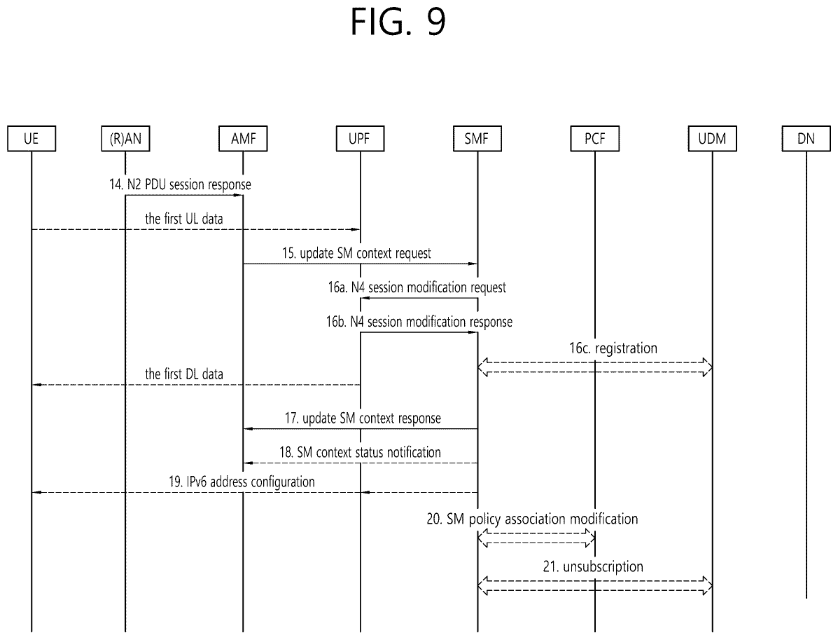

FIGS. 8 and 9 Show an Example of a PDU Session Establishment Procedure to which Implementations of the Present Disclosure is Applied.

A PDU session establishment may correspond to:
a UE initiated PDU session establishment procedure.
a UE initiated PDU session handover between 3GPP and non-3GPP.
a UE initiated PDU session handover from EPS to 5GS.
a network triggered PDU session establishment procedure.

A PDU session may be associated either (a) with a single access type at a given time, i.e., either 3GPP access or non-3GPP access, or (b) simultaneously with multiple access types, i.e., one 3GPP access and one non-3GPP access. A PDU session associated with multiple access types is referred to as multi access PDU (MA PDU) session and it may be requested by access traffic steering, switching, splitting (ATSSS)-capable UEs.

FIGS. 8 and 9 specify the procedures for establishing PDU sessions associated with a single access type at a given time.

The procedure shown in FIGS. 8 and 9 assumes that the UE has already registered on the AMF thus unless the UE is emergency registered the AMF has already retrieved the user subscription data from the UDM.

First, procedures of FIG. 8 are described.

(1) Step 1: In order to establish a new PDU session, the UE generates a new PDU session ID.

The UE initiates the UE requested PDU session establishment procedure by the transmission of a NAS message containing a PDU Session Establishment Request message within the N1 SM container. The PDU Session Establishment Request message includes a PDU session ID, Requested PDU Session Type, a Requested session and service continuity (SSC) mode, 5GSM Capability, protocol configuration options (PCO), SM PDU DN Request Container, UE Integrity Protection Maximum Data Rate, etc.

The Request Type indicates “Initial request” if the PDU session establishment is a request to establish a new PDU session and indicates “Existing PDU Session” if the request refers to an existing PDU session switching between 3GPP access and non-3GPP access or to a PDU session handover from an existing packet data network (PDN) connection in EPC. The Request Type indicates “Emergency Request” if the PDU session establishment is a request to establish a PDU session for emergency services. The Request Type indicates “Existing Emergency PDU Session” if the request refers to an existing PDU session for emergency services switching between 3GPP access and non-3GPP access or to a PDU session handover from an existing PDN connection for emergency services in EPC.

The UE includes the S-NSSAI from the Allowed NSSAI of the current access type. If the Mapping of Allowed NSSAI was provided to the UE, the UE shall provide both the S-NSSAI of the visited PLMN (VPLMN) from the Allowed NSSAI and the corresponding S-NSSAI of the HPLMN from the Mapping Of Allowed NSSAI.

(2) Step 2: The AMF selects an SMF. If the Request Type indicates “Initial request” or the request is due to handover from EPS or from non-3GPP access serving by a different AMF, the AMF stores an association of the S-NSSAI(s), the data network name (DNN), the PDU session ID, the SMF ID as well as the Access Type of the PDU session.

If the Request Type is “initial request” and if the Old PDU session ID indicating the existing PDU session is also contained in the message, the AMF selects an SMF and stores an association of the new PDU Session ID, the S-NSSAI(s), the selected SMF ID as well as Access Type of the PDU Session.

If the Request Type indicates “Existing PDU Session”, the AMF selects the SMF based on SMF-ID received from UDM. The AMF updates the Access Type stored for the PDU session.

If the Request Type indicates “Existing PDU Session” referring to an existing PDU session moved between 3GPP access and non-3GPP access, then if the serving PLMN S-NSSAI of the PDU session is present in the Allowed NSSAI of the target access type, the PDU session establishment procedure can be performed in the following cases:
the SMF ID corresponding to the PDU session ID and the AMF belong to the same PLMN;
the SMF ID corresponding to the PDU session ID belongs to the HPLMN;

Otherwise the AMF shall reject the PDU session establishment request with an appropriate reject cause.

The AMF shall reject a request coming from an emergency registered UE and the Request Type indicates neither “Emergency Request” nor “Existing Emergency PDU Session”.

(3) Step 3: If the AMF does not have an association with an SMF for the PDU session ID provided by the UE (e.g., when Request Type indicates “initial request”), the AMF invokes Create SM Context Request procedure (e.g., Nsmf_PDUSession_CreateSMContext Request). If the AMF already has an association with an SMF for the PDU session ID provided by the UE (e.g., when Request Type indicates “existing PDU Session”), the AMF invokes Update SM Context Request procedure (e.g., Nsmf_PDUSession_UpdateSMContext Request).

The AMF sends the S-NSSAI of the serving PLMN from the Allowed NSSAI to the SMF. For roaming scenario in local breakout (LBO), the AMF also sends the corresponding S-NSSAI of the HPLMN from the Mapping Of Allowed NSSAI to the SMF.

The AMF ID is the UE's GUAMI which uniquely identifies the AMF serving the UE. The AMF forwards the PDU session ID together with the N1 SM container containing the PDU Session Establishment Request message received from the UE. The generic public subscription identifier (GPSI) shall be included if available at AMF.

The AMF provides the PEI instead of the SUPI when the UE in limited service state has registered for emergency services without providing a SUPI. In case the UE in limited service state has registered for Emergency services with a SUPI but has not been authenticated, the AMF indicates that the SUPI has not been authenticated. The SMF determines that the UE has not been authenticated when it does not receive a SUPI for the UE or when the AMF indicates that the SUPI has not been authenticated.

The AMF may include a PCF ID in the Nsmf_PDUSession_CreateSMContext Request.

This PCF ID identifies the home PCF (H-PCF) in the non-roaming case and the visited PCF (V-PCF) in the LBO roaming case.

(4) Step 4: If session management subscription data for corresponding SUPI, DNN and S-NSSAI of the HPLMN is not available, then SMF may retrieve the session management subscription data from the UDM and subscribes to be notified when this subscription data is modified.

(5) Step 5: The SMF transmits either Create SM Context Response message (e.g., Nsmf_PDUSession_CreateSMContext Response) or Update SM Context Response message (e.g., Nsmf_PDUSession_UpdateSMContext Response) to the AMF, depending on the request received in step 3.

If the SMF received Nsmf_PDUSession_CreateSMContext Request in step 3 and the SMF is able to process the PDU session establishment request, the SMF creates an SM context and responds to the AMF by providing an SM Context ID.

When the SMF decides to not accept to establish a PDU session, the SMF rejects the UE request via NAS SM signaling including a relevant SM rejection cause by responding to the AMF with Nsmf_PDUSession_CreateSMContext Response. The SMF also indicates to the AMF that the PDU session ID is to be considered as released, the SMF proceeds to step 20 below and the PDU session establishment procedure is stopped.

(6) Step 6: Optional secondary authentication/authorization may be performed.

(7a) Step 7a: If dynamic policy and charging control (PCC) is to be used for the PDU session, the SMF may perform PCF selection.

(7b) Step 7b: The SMF may perform an SM Policy Association Establishment procedure to establish an SM Policy association with the PCF and get the default PCC rules for the PDU session.

(8) Step 8: The SMF selects one or more UPFs.

(9) Step 9: The SMF may perform an SMF initiated SM Policy Association Modification procedure to provide information on the policy control request trigger condition(s) that have been met.

(10) Step 10: If Request Type indicates “initial request”, the SMF may initiate an N4 Session Establishment procedure with the selected UPF. Otherwise, the SMF may initiate an N4 Session Modification procedure with the selected UPF

In step 10a, the SMF may send an N4 Session Establishment/Modification Request to the UPF and provides packet detection, enforcement and reporting rules to be installed on the UPF for this PDU session. In step 10b, the UPF may acknowledge by sending an N4 Session Establishment/Modification Response.

(11) Step 11: The SMF transmits a NIN2Message Transfer message (e.g., Namf_Communication_NIN2MessageTransfer) to the AMF.

The NIN2Message Transfer message may include N2 SM information. The N2 SM information carries information that the AMF shall forward to the (R)AN which may include:
The CN Tunnel Info: Core network address(es) of the N3 tunnel corresponding to the PDU session;
One or multiple quality of service (QoS) profiles and the corresponding QoS flow IDs (QFIs);
The PDU session ID: indicate to the UE the association between (R)AN resources and a PDU session for the UE.
S-NSSAI with the value for the serving PLMN (i.e., the HPLMN S-NSSAI or, in LBO roaming case, the VPLMN S-NSSAI).
User Plane Security Enforcement information determined by the SMF.
If the User Plane Security Enforcement information indicates that integrity protection is “Preferred” or “Required”, the SMF also includes the UE Integrity Protection Maximum Data Rate as received in the PDU Session Establishment Request message.
Redundancy sequence number (RSN) parameter

The NIN2Message Transfer message may include N1 SM container. The N1 SM container contains the PDU Session Establishment Accept message that the AMF shall provide to the UE. The PDU Session Establishment Accept message includes S-NSSAI from the Allowed NSSAI. For LBO roaming scenario, the PDU Session Establishment Accept message includes the S-NSSAI from the Allowed NSSAI for the VPLMN and also it includes the corresponding S-NSSAI of the HPLMN from the Mapping Of Allowed NSSAI that SMF received in step 3.

Multiple QoS Rules, QoS flow level, QoS parameters if needed for the QoS Flow(s) associated with those QoS rule(s) and QoS Profiles may be included in the PDU Session Establishment Accept message within the N1 SM container and in the N2 SM information.

If the PDU session establishment failed anywhere between step 5 and step 11, then the NIN2Message Transfer message shall include the N1 SM container with a PDU Session Establishment Reject message and shall not include any N2 SM information. The (R)AN sends the NAS message containing the PDU Session Establishment Reject message to the UE. In this case, steps 12-17 are skipped.

(12) Step 12: The AMF sends the NAS message containing PDU Session ID and PDU Session Establishment Accept message targeted to the UE and the N2 SM information received from the SMF within the N2 PDU Session Request message to the (R)AN.

(13) Step 13: The (R)AN may issue AN specific signaling exchange with the UE that is related with the information received from SMF. For example, in case of a NG-RAN, an RRC connection reconfiguration may take place with the UE establishing the necessary NG-RAN resources related to the QoS rules for the PDU session request received in step 12.

The (R)AN forwards the NAS message (PDU Session ID, N1 SM container (PDU Session Establishment Accept message)) provided in step 12 to the UE. The (R)AN shall only provide the NAS message to the UE if the AN specific signaling exchange with the UE includes the (R)AN resource additions associated to the received N2 command.

If the N2 SM information is not included in the step 11, then the following steps 14 to 16b and step 17 are omitted.

Now, procedures of FIG. 9, which follow the procedures of FIG. 8, are described.

(14) Step 14: The (R)AN transmits a N2 PDU Session Response message to the AMF. The N2 PDU Session Response message may include PDU session ID, Cause, N2 SM information (PDU Session ID, AN Tunnel Info, List of accepted/rejected QFI(s), User Plane Enforcement Policy Notification)), etc.

(15) Step 15: The AMF transmits an Update SM Context Request message (e.g., Nsmf_PDUSession_UpdateSMContext Request) to the SMF. The AMF forwards the N2 SM information received from (R)AN to the SMF.

(16a) Step S16a: The SMF initiates an N4 Session Modification procedure with the UPF. The SMF provides AN Tunnel Info to the UPF as well as the corresponding forwarding rules.

(16b) Step S16b: The UPF provides an N4 Session Modification Response to the SMF.

After this step, the UPF may deliver any DL packets to the UE that may have been buffered for this PDU session.

(16c) Step 16c: If the SMF has not yet registered for this PDU session, then the SMF may register with the UDM for a given PDU Session.

(17) Step 17: The SMF transmits an Update SM Context Response message (e.g., Nsmf_PDUSession_UpdateSMContext Response) to the AMF.

After this step, the AMF forwards relevant events subscribed by the SMF.

(18) Step 18: If during the procedure, any time after step 5, the PDU session establishment is not successful, the SMF may inform the AMF by invoking Nsmf_PDUSession_SMContextStatusNotify (Release). The SMF may also release any N4 session(s) created, any PDU session address if allocated (e.g., IP address) and release the association with PCF, if any. In this case, step 19 is skipped.

(19) Step 19: In the case of PDU Session Type IPV6 or IPv4v6, the SMF may generate an IPV6 Router Advertisement and send it to the UE.

(20) Step 20: The SMF may perform SMF initiated SM Policy Association Modification.

(21) Step 21: If the PDU Session establishment failed after step 4, the SMF may unsubscribe to the modifications of session management subscription data, if the SMF is no more handling a PDU session of the UE.

### <Access to Overlay Networks Through Underlay Networks>

A UE may access an overlay network through an underlay network.

Overlay network: When UE is accessing SNPN service via NWu using user plane established in PLMN, SNPN is the overlay network. When UE is accessing PLMN services via NWu using user plane established in SNPN, PLMN is the overlay network.

Underlay network: When UE is accessing SNPN service via NWu using user plane established in PLMN, PLMN is the underlay network. When a UE accesses a PLMN service via NWu using a user plane configured in SNPN, the SNPN is the underlay network.

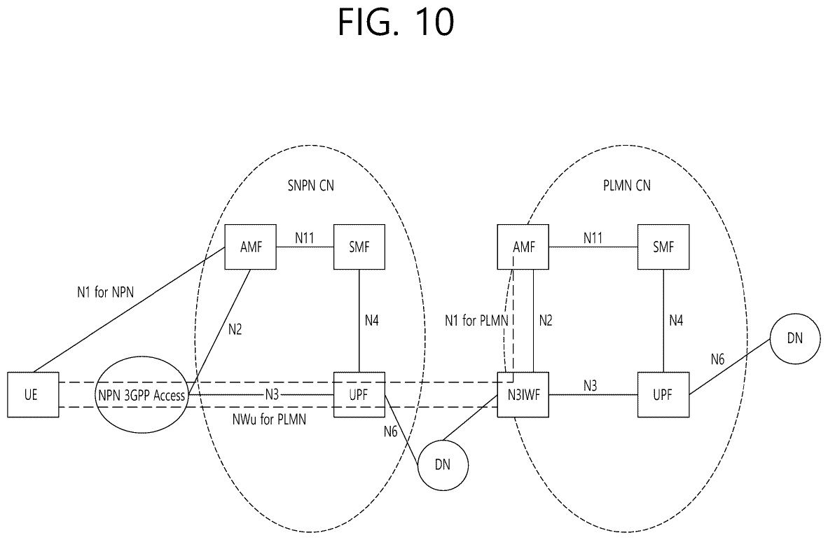

### FIG. 10 Shows an Example of Accessing a PLMN Service Via an SNPN.

The SNPN corresponds to the underlay network, and the PLMN corresponds to the overlay network.

When a UE camps on the NG-RAN of a Stand-alone Non-Public Network (SNPN), to access PLMN services, the UE acquires an IP connection and searches for and establishes a connection to the N3IWF in the PLMN.

“N1 for NPN” indicates a reference point between the UE and the AMF in the SNPN. “NWu for PLMN” indicates a reference point between the UE and the N3IWF in the PLMN to establish a secure tunnel between the UE and the N3IWF over the SNPN. “N1 for PLMN” indicates a reference point between the UE and the AMF in the PLMN.

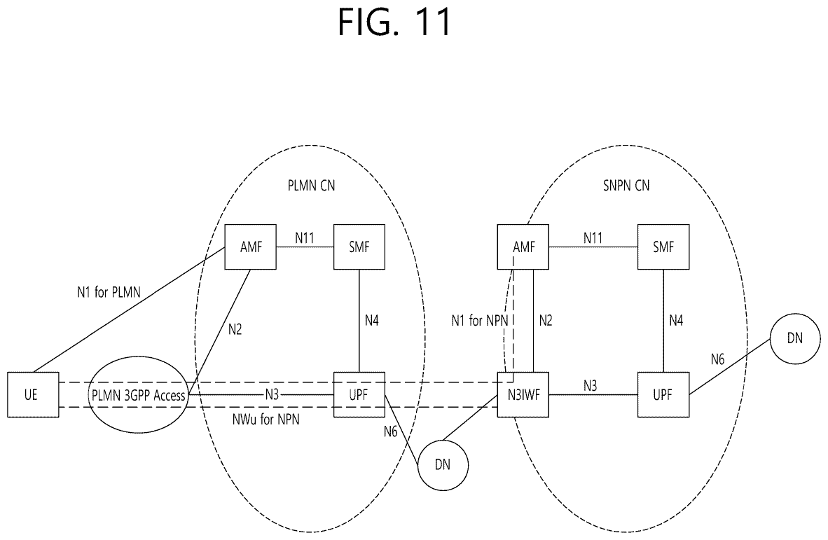

### FIG. 11 Shows an Example of Accessing SNPN Services Via a PLMN.

The PLMN corresponds to the underlay network, and the SNPN corresponds to the overlay network.

When a UE camps on the NG-RAN of a PLMN, to access NPN services, the UE acquires an IP connection and searches for and establishes a connection to the N3IWF in the SNPN.

‘N1 for PLMN’ indicates the reference point between the UE and the AMF in the PLMN. ‘NWu for NPN’ indicates the reference point between the UE and the N3IWF in the SNPN for establishing a secure tunnel between the UE and the N3IWF through the PLMN. ‘N1 for NPN’ indicates the reference point between the UE and the AMF in the NPN.

When accessing an overlay network through the underlay network using the aforementioned mechanism, the overlay network acts as an authorized third party with an AF, interacting with the NEF in the underlay network and utilizing existing network exposure capabilities provided by the underlay network.

If a UE receives a service from the overlay network that is not provided by the underlay network, the QoS of that service may be degraded.

The UE may support the overlay architecture. For example, the UE may access the non-3GPP access of the PLMN via the SNPN while connected to the SNPN. Conversely, the UE may access the non-3GPP access of the SNPN via the PLMN while connected to the PLMN.

When a terminal receives localized services in the SNPN, the terminal may connect to the home network using an overlay architecture to simultaneously receive services from the home network (PLMN).

When a terminal receives services using an overlay architecture, the underlay network and the overlay network may be connected via the general Internet. In this case, to ensure QoS, a service level agreement may be required between the operators connecting the two networks and the Internet.

The service level agreement determines the supportable QoS level. This determined QoS level may not satisfy the QoS for all services provided on the home network.

When a terminal accesses the home network via an underlay network (e.g., the SNPN), the home network operator may want to restrict the services the terminal can use.

For example, the operator may allow VoWiFi calls only when the terminal is roaming within the network. Furthermore, the operator may not allow VoWiFi calls to a terminal when connecting from a home network.

In this way, depending on the business model of the home network operator, only certain services can be used.

A terminal may connect to the home network via an underlay network. For example, the underlay network may not support VoWiFi calls (or may support them with a low QoS). In this case, if the terminal receives VoWiFi call services from the home network, the service may have a low QoS because it passes through the underlay network. Therefore, to prevent this problem, the home network operator may need a method to prevent certain services from being supported on certain underlay networks in the aforementioned scenario.

If a terminal connects to the home network via an underlay network (e.g., SNPN), the home network operator may restrict the services that the terminal can use on the home network.

The methods proposed in this specification may be performed or used in combination or complementary manner. The methods proposed in this specification may be performed in combination with each other.

The list of services (or information) available for each underlay network in this specification may be: information about services that the terminal can receive from the PLMN through a specific underlay network when accessing the PLMN through that specific underlay network. For example, the list of services (or information) available for each underlay network may be information about services available based on the a underlay network being specific underlay network. An example of the list of services (or information) available for each underlay network may be as shown in Table 3.

The list of services (or information) available for each underlay network in this specification may be information about multiple networks.

During the process of registering a terminal with a home network (or after registration), when the terminal accesses the home network through the underlay network, the home network may provide information about the list of services available for each underlay network.

The aforementioned information may be stored for each UE as subscription information in the UDM.

Based on this, the AMF may transmit the information to the terminal through a Registration Accept or UE Configuration Update message.

Alternatively, the aforementioned information may be stored in the Unified Data Repository (UDR). The PCF may transmit the information stored in the UDR to the terminal in the form of a new UE policy.

For example, the terminal may receive information on available services for each underlay network from the home network.

Table 3 shows examples of information on available services for each underlay network.

TABLE 3

| IE name | Description |
|---|---|
| Allowed underlay | Underlay network identities (e.g. SNPN ID, |
| network | PLMN ID) |
| > Traffic descriptor | Traffic filter |
| | DNN / S-NSSAI |
| | Connection Capabilities |
| | IMS Voice Service |

For example, a terminal may receive information as shown in Table 3 from a home network. When the terminal accesses the home network using the network corresponding to the “Allowed underlay network” as the underlay network, the terminal may receive the service corresponding to the “Traffic descriptor” from the home network. For example, when the terminal accesses the home network using the network corresponding to the “Allowed underlay network” as the underlay network, the terminal establishes a session for the service corresponding to the “Traffic descriptor” and may receive the service corresponding to the “Traffic descriptor” from the home network.

The “Allowed underlay network” may be the identity of an underlay network. The “Allowed underlay network” may be the identities of multiple underlay networks.

For example, the “Allowed underlay network” may be an SNPN ID or a PLMN ID.

For example, the “Allowed underlay network” may be in the form of all PLMNs, all SNPNs, or all networks.

A ‘Traffic descriptor’ may indicate permitted traffic.

For example, a ‘Traffic descriptor’ may be a traffic filter. When a terminal accesses a home network using a network corresponding to an underlay network identity as an underlay network, the terminal may receive services corresponding to a specific traffic filter from the home network.

For example, a ‘Traffic descriptor’ may be a DNN (Data Network Name)/S-NSSAI (Single Network Slice Selection Assistance Information). When a terminal accesses a home network using a network corresponding to an underlay network identity as an underlay network, the terminal may receive services corresponding to the DNN/S-NSSAI from the home network.

For example, a ‘Traffic descriptor’ may be connection capabilities. When a terminal accesses a home network using a network corresponding to an underlay network identity as an underlay network, the terminal may receive services corresponding to the connection capabilities from the home network.

For example, the ‘Traffic descriptor’ may be an IMS voice service. If a terminal accesses the home network using the network corresponding to the underlay network identity as the underlay network, the terminal may receive IMS voice services from the home network.

For example, the ‘Traffic descriptor’ may be a value indicating that all services are permitted. If a terminal accesses the home network using the network corresponding to the underlay network identity as the underlay network, the terminal may receive all services from the home network.

For example, the ‘Traffic descriptor’ may be a null value or a value indicating that no services are permitted. If a terminal accesses the home network using the network corresponding to the underlay network identity as the underlay network, the terminal may not receive any services from the home network.

When a terminal accesses a home network through an underlay network and receives the aforementioned information (e.g., information as shown in Table 3), the terminal may establish a session only for services permitted by the home network based on the received information and receive the services.

During the home network registration process, the terminal may notify the home network of its support capabilities for the list of available services for each underlay network through the “UE 5GMM Core Network Capability”. For example, when a terminal sends a registration request message to the home network, the terminal may include information about capability to support the list of available services for each underlay network in the “UE 5GMM Core Network Capability” field of the registration request message.

The AMF may receive information about the capability from the terminal. The AMF may then transmit the information about the capability to the PCF.

Alternatively, the terminal may include the information about the capability in a UE policy container and transmit it directly to the PCF.

Based on the information about the capability, the AMF or PCF may determine whether to transmit service information (e.g., information as shown in Table 3) available for each underlay network to the terminal.

Service information available for each underlay network (e.g., information as shown in Table 3) may be included in a URSP rule and transmitted to the terminal. For example, it may be included in the “allowed underlay network” information in the Route Selection Descriptor (RSD) of the URSP rule.

Table 4 shows an example of an RSD that includes “allowed underlay network” information.

TABLE 4

| | | | PCF permitted | |
|---|---|---|---|---|
| Information | | | to modify in | |
| name | Description | Category | URSP | Scope |
| Route | Determines the order in | Mandatory | Yes | UE context |
| Selection | which the Route Selection | (NOTE 1) | | |
| Descriptor | Descriptors are to be | | | |
| Precedence | applied. | | | |
| Route | This part defines the route | Mandatory | | |
| selection | selection components | (NOTE 2) | | |
| components | | | | |
| SSC Mode | One single value of SSC | Optional | Yes | UE context |
| Selection | mode.(NOTE 5) | | | |
| Network | Either a single value or a | Optional(NOTE | Yes | UE context |
| Slice | list of values of S- | 3) | | |
| Selection | NSSAI(s). | | | |
| DNN | Either a single value or a | Optional | Yes | UE context |
| Selection | list of values of DNN(s). | | | |
| PDU Session | One single value of PDU | Conditional(NOTE | Yes | UE context |
| Type | Session Type | 8) | | |
| Selection | | | | |
| Non- | Indicates if the traffic of | Optional(NOTE | Yes | UE context |
| Seamless | the matching application is | 4) | | |
| Offload | to be offloaded to non- | | | |
| indication | 3GPP access outside of a | | | |
| | PDU Session. | | | |
| ProSe Layer- | Indicates if the traffic of | Optional(NOTE | Yes | UE context |
| 3 UE-to- | the matching application is | 4) | | |
| Network | to be sent via a ProSe | | | |
| Relay Offload | Layer-3 UE-to-Network | | | |
| indication | Relay outside of a PDU | | | |
| | session. | | | |
| ProSe Multi- | Indicates if the traffic of | Optional(NOTE | Yes | UE context |
| path | the matching application is | 9) | | |
| Preference | preferred to be sent via a | | | |
| | PDU Session over the Uu | | | |
| | reference point and a ProSe | | | |
| | Layer-3 UE-to-Network | | | |
| | Relay outside of a PDU | | | |
| | session. | | | |
| Access Type | Indicates the preferred | Optional | Yes | UE context |
| preference | Access Type (3GPP or non- | | | |
| | 3GPP or Multi-Access) | | | |
| | when the UE establishes a | | | |
| | PDU Session for the | | | |
| | matching application. | | | |
| PDU Session | An indication shared by | Optional | Yes | UE context |
| Pair ID | redundant PDU Sessions as | | | |
| | described in clause 5.33.2.1 | | | |
| | of TS 23.501 [2]. | | | |
| RSN | The RSN as described in | Optional | Yes | UE context |
| | clause 5.33.2.1 of | | | |
| | TS 23.501 [2]. | | | |
| Route | This part defines the Route | Optional | | |
| Selection | Validation Criteria | | | |
| Validation | components | | | |
| Criteria(NOTE | | | | |
| 6) | | | | |
| Time Window | The time window when the | Optional | Yes | UE context |
| | matching traffic is allowed. | | | |
| | The RSD is not considered | | | |
| | to be valid if the current | | | |
| | time is not in the time | | | |
| | window. | | | |
| Location | The UE location where the | Optional | Yes | UE context |
| Criteria | matching traffic is allowed. | | | |
| | The RSD rule is not | | | |
| | considered to be valid if | | | |
| | the UE location does not | | | |
| | match the location criteria. | | | |
| Allowed | Underlay network | Optional | | |
| underlay | identities where the UE is | | | |
| network | allowed to access home | | | |
| | network via underlay | | | |
| | network | | | |

NOTE 1:
Every Route Selection Descriptor in the list shall have a different precedence value.
NOTE 2:
At least one of the route selection components shall be present.
NOTE 3:
When the Subscription Information contains only one S-NSSAI in UDR, the PCF needs not provision the UE with S-NSSAI in the Network Slice Selection information. The “match all” URSP rule has one S-NSSAI at most.
NOTE 4:
If this indication is present in a Route Selection Descriptor, no other components shall be included in the Route Selection Descriptor.
NOTE 5:
The SSC Mode 3 shall only be used when the PDU Session Type is IP.
NOTE 6:
The Route Selection Descriptor is not considered valid unless all the provided Validation Criteria are met.
NOTE 7:
In this Release of specification, inclusion of the Validation Criteria in Roaming scenarios is not considered.
NOTE 8:
This component shall be present when the Route Selection Component does neither include the “Non-Seamless Offload indication” nor “ProSe Layer-3 UE-to-Network Relay Offload indication”.
NOTE 9:
If this indication is present in a Route Selection Descriptor, ProSe Layer-3 UE-to-Network Relay Offload indication shall not be included in the Route Selection Descriptor.

The RSD may include an “Allowed underlay network”. “Allowed underlay network” may include the underlay network ID that allows the terminal to access the home network through the underlay network. “Allowed underlay network” may be optionally included in the RSD.

Instead of a separate IE, such as “Allowed underlay network,” the underlay network ID information may be transmitted to the terminal via “Location Criteria.”

The PCF may also provide information on services available in the underlay network (rules indicating services available in the underlay network) to the terminal by including underlay network-specific URSP rule in a URSP rule.

For example, to indicate that the URSP rule is for a specific underlay network, the underlay network ID information may be included in the Policy Section Identifier (PSI) that composes the URSP rule. Additionally, the URSP rule for a specific underlay network (underlay network specific URSP rule) may only be composed of URSP rules used only in that underlay network.

If a terminal receives, from the PCF, a URSP rule containing service information available for each underlay network (rules indicating the services available for each underlay network) in the form of a URSP rule for a specific underlay network (underlay network specific URSP rule), when the terminal accesses the home network through the underlay network, the URSP rule for the specific underlay network (underlay network specific URSP rule) must be evaluated first. If no rule matching the URSP rule for the specific underlay network (underlay network specific URSP rule) is found, the process of establishing a PDU session through the URSP rule must be aborted.

When a terminal accesses a home network via an underlay network, the terminal may receive, from the PCF, a URSP rule (underlay network-specific URSP rule), which contains information on available services for each underlay network (rules indicating the available services for each underlay network). In this case, the terminal may first evaluate the URSP rule for the specific underlay network. If the evaluation result indicates that a content (content matching the service the terminal is attempting to establish and the underlay network used by the terminal) does not exist the URSP rule for the specific underlay network (underlay network specific URSP rule), the terminal may stop the process of establishing a PDU session using the received URSP rule.

For example, the terminal may access a PLMN using the first SNPN as the underlay network. The terminal may initiate the process of establishing a PDU session for the PLMN and IMS call service. The terminal may receive a URSP rule from the PCF of the PLMN. The URSP rule may include information on services available through the first SNPN. If the URSP rule received by the terminal does not contain information on an IMS call service, the terminal may stop the PDU session establishment process for the IMS call service.

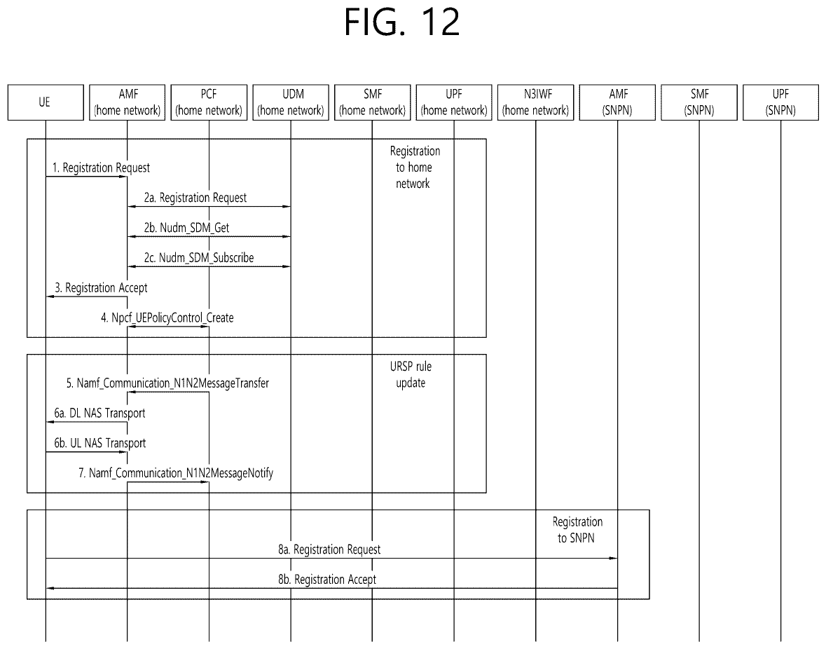

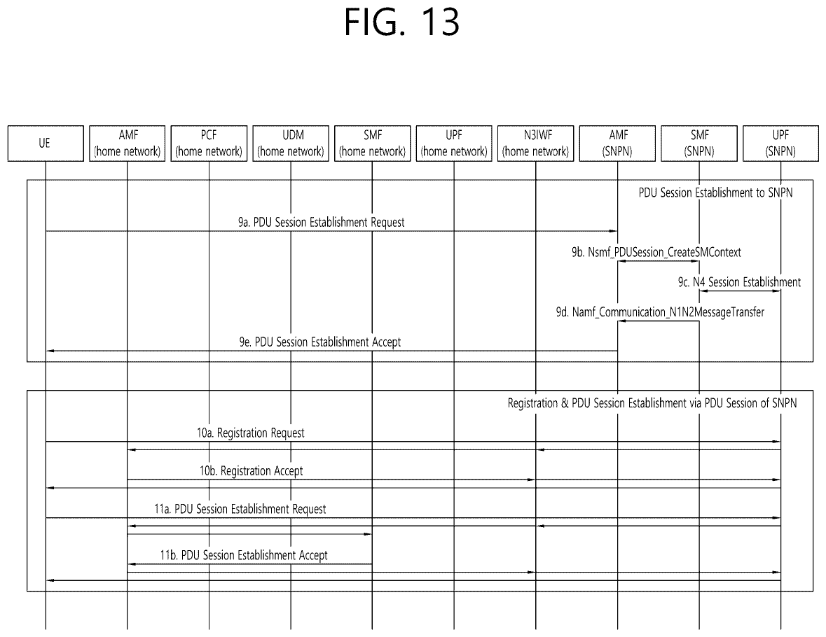

### FIGS. 12 and 13 Show Examples of Procedures According to Embodiments of the Present Disclosure.

FIGS. 12 and 13 show the process by which a terminal receives service information available for each underlay network and receives services based on the received information.

FIGS. 12 and 13 show the process by which a terminal receives a policy upon registering with a PLMN, and then receives services from a PLMN (overlay network) through an SNPN (underlay network) based on this policy.

The content described in FIGS. 6 and 7 above may be applied to FIGS. 12 and 13.

Step 1. The terminal may transmit a Registration Request message to the home network. The content described in FIGS. 6 and 7 above may be applied to this message.

The Registration Request may include information indicating the capability for service control for each underlay network.

The Registration Request may include a policy container. The policy container may include information indicating the capability for supporting service control for each underlay network. In this case, the terminal may receive service information for each underlay network through the URSP rule, verify/evaluate the information, and apply it.

Step 2. The AMF may perform a registration process according to conventional procedures. The details described above in FIGS. 6 and 7 may be applied to this process.

The AMF may retrieve the terminal's subscriber information and register information about the terminal's serving AMF in the UDM. The terminal's subscriber information in the UDM may contain information about whether the terminal supports services via the underlay network.

Step 3. The AMF may send a Registration Accept message to the terminal. The details described above in FIGS. 6 and 7 may be applied to this process.

If the terminal has the capability to control services for each underlay network, the home network may transmit information about available services for each underlay network to the terminal.

If a terminal has the capability to control services per underlay network, the registration accept message sent to the terminal may include information about services available to the terminal per underlay network.

For example, the registration approval message sent to the terminal may include information about DNN/S-NSSAI or available services for each underlay network.

Based on the information contained in the terminal's subscriber information regarding whether services via the underlay network are permitted for the terminal, the home network may determine whether to provide the terminal with a policy including information about DNN/S-NSSAI or available services for each underlay network.

For example, the registration accept message may include information about available services for each underlay network.

Step 4. If service information for each underlay network is transmitted to the terminal via a URSP rule, the AMF may forward the policy container transmitted by the terminal to the PCF. The details described above in FIGS. 6 and 7 may be applied to this.

The policy container transmitted by the terminal may include information regarding the terminal's capability to support service control for each underlay network.

Furthermore, the AMF may inform the PCF, based on subscriber information, that the terminal supports services via the underlay network.

Step 5. The PCF may decide to update the URSP rule. The PCF may transmit a policy container containing the updated URSP rule to the AMF.

Based on the capability provided by the terminal, PSI information, and subscriber information received from the AMF, the PCF may update the URSP rule. The updated URSP rule may include information regarding the Allowed Underlay Network.

The updated URSP rule transmitted to the terminal may include information regarding the Allowed Underlay Network.

If the PCF decides to update a URSP rule, it may perform the URSP rule update.

The PCF may include allowed underlay network information in the validity condition of the RSD portion of the URSP rule and transmit it to the AMF. The PCF may then transmit a policy container containing the updated URSP rule to the AMF.

Step 6. The AMF may transmit the policy container provided by the PCF to the terminal. The AMF may transmit the policy container received from the PCF to the terminal.

The terminal may store the URSP rule contained in the policy container. The terminal may then transmit the policy container to the AMF in response to the PCF.

Step 7. The AMF may transmit the policy container received from the terminal to the PCF.

Step 8. The terminal may decide to access the SNPN and perform registration with the SNPN. The terminal may send a registration request message to the SNPN. The terminal may receive a registration accept message from the SNPN.

For example, the terminal may decide to receive localized services through the SNPN. Based on SNPN selection information received from the home network, the terminal may select an SNPN and perform the registration process with the SNPN.

Step 9. Based on a policy provided by the home network, the terminal may decide to receive services from the home network through the underlay network. Furthermore, the terminal may perform a PDU session establishment procedure through the SNPN. For example, the terminal may perform a PDU session establishment procedure for accessing the overlay network.

Based on the available service information for each underlay network received from the home network, the terminal may decide to receive services from the home network using the SNPN registered in Step 9 as the underlay network. Based on the above determination, the terminal may perform establishment procedure of a first PDU session with the SNPN. The PDU session may be a PDU session for accessing an overlay network (e.g., a home network).

Step 10. The terminal may perform a registration procedure with the home network via the N3IWF of the home network through the first PDU session (the PDU session with the SNPN).

Step 11. The terminal may establish a second PDU session with the home network via the N3IWF of the home network through the first PDU session (the PDU session with the SNPN).

Traffic for the second PDU session (such as a session request message, a session accept message, and data through the session) may be transmitted between the terminal and the home network via the UPF of the SNPN.

The terminal may receive necessary home network services through the second PDU session.

The home network may transmit information about the services allowed for each underlay network to the terminal. As a result, the terminal can receive a specific service through a specific network allowed by the home network (QoS supported).

The drawings below are created to illustrate specific examples of the present specification. The names of specific devices or names of specific signals/messages/fields depicted in the drawings are presented as examples, and therefore the technical features of the present specification are not limited to the specific names used in the drawings below.

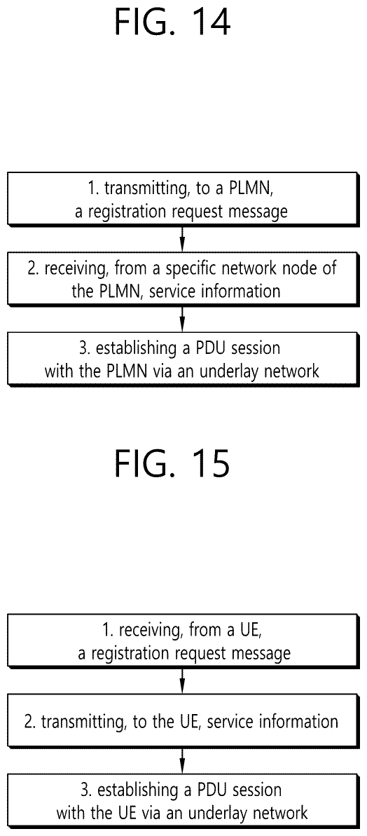

### FIG. 14 Shows the Procedure of the UE According to Disclosure of the Present Specification.

1. The UE may transmit, to a Public Land Mobile Network (PLMN), a registration request message.

2. The UE may receive, from a specific network node of the PLMN, service information, based on the registration request message.

3. The UE may establish a Packet Data Unit (PDU) session with the PLMN via an underlay network, based on the service information.

The registration request message may include capability information.

The capability information may include information that the UE supports information about available services based on the underlay network.

Based on the underlay network being a first network, the service information may include information that a first service is available.

Based on the underlay network being the first network, the PDU session may be for the first service.

The first network may be a Standalone Non-Public Network (SNPN).

The specific network node may be an Access and Mobility management Function (AMF).

The step of receiving the service information may be receiving a registration accept message including the service information.

The specific network node may be a Policy Control Function (PCF).

The step of receiving the service information may be receiving a UE route selection policy (URSP) rule including the service information.

The UE may receive, from the PLMN, the first service via the first network, based on the PDU session being established.

Based on the underlay network being the first network, the service information may include information that a second service is available,

Based on the underlay network being the first network, the PDU session may be for the second service.

Based on the underlay network being a second network, the service information may include information that a third service is available,

Based on the underlay network being the second network, the PDU session may be for the third service.

Based on the underlay network being the first network, a traffic related to the PDU session may be through a User Plane Function (UPF) of the first network.

The drawings below are created to illustrate specific examples of the present specification. The names of specific devices or names of specific signals/messages/fields depicted in the drawings are presented as examples, and therefore the technical features of the present specification are not limited to the specific names used in the drawings below.

### FIG. 15 Shows the Procedure of the PLMN According to Disclosure of the Present Specification.

1. The PLMN may receive, from a UE, a registration request message.

2. The PLMN may transmit, to the UE, service information, based on the registration request message.

3. The PLMN may establish a PDU session with the UE via an underlay network, based on the service information.

The registration request message may include capability information.

The capability information may include information that the UE supports information about available services based on the underlay network.

Based on the underlay network being a first network, the service information may include information that a first service is available,

Based on the underlay network being the first network, the PDU session may be for the first service.

The first network may be a SNPN.

The step of transmitting the service information may be that an AMF of the PLMN transmits a registration accept message including the service information.

The step of transmitting the service information may be that a PCF of the PLMN transmits an URSP rule including the service information.

The PLMN may provide, to the UE, the first service via the first network, based on the PDU session being established.

Based on the underlay network being the first network, the service information may include information that a second service is available.

Based on the underlay network being the first network, the PDU session may be for the second service.

Based on the underlay network being a second network, the service information may include information that a third service is available,

Based on the underlay network being the second network, the PDU session may be for the third service.

Based on the underlay network being the first network, a traffic related to the PDU session may be through a UPF of the first network.

Hereinafter, an apparatus for performing communication according to some embodiments of the present specification will be described.

For example, an apparatus may include a processor, a transceiver, and a memory.

For example, a processor may be configured to be operably coupled with a memory and a processor.

The processor may perform: transmitting, to a Public Land Mobile Network (PLMN), a registration request message; receiving, from a specific network node of the PLMN, service information, based on the registration request message; and establishing a Packet Data Unit (PDU) session with the PLMN via an underlay network, based on the service information, wherein the registration request message includes capability information, wherein the capability information includes information that the UE supports information about available services based on the underlay network, wherein, based on the underlay network being a first network, the service information includes information that a first service is available, wherein, based on the underlay network being the first network, the PDU session is for the first service.

Hereinafter, a processor for providing communication according to some embodiments of the present specification will be described.

The processor is configured to: transmitting, to a Public Land Mobile Network (PLMN), a registration request message; receiving, from a specific network node of the PLMN, service information, based on the registration request message; and establishing a Packet Data Unit (PDU) session with the PLMN via an underlay network, based on the service information, wherein the registration request message includes capability information, wherein the capability information includes information that the UE supports information about available services based on the underlay network, wherein, based on the underlay network being a first network, the service information includes information that a first service is available, wherein, based on the underlay network being the first network, the PDU session is for the first service.

Hereinafter, a non-volatile computer readable medium storing one or more instructions for providing multicast service in wireless communication according to some embodiments of the present specification will be described.

According to some embodiments of the present disclosure, the technical features of the present disclosure may be directly implemented as hardware, software executed by a processor, or a combination of the two. For example, in wireless communication, a method performed by a wireless device may be implemented in hardware, software, firmware, or any combination thereof. For example, the software may reside in RAM memory, flash memory, ROM memory, EPROM memory, EEPROM memory, registers, hard disk, removable disk, CD-ROM, or other storage medium.

Some examples of a storage medium are coupled to the processor such that the processor can read information from the storage medium. Alternatively, the storage medium may be integrated into the processor. The processor and storage medium may reside in the ASIC. For another example, a processor and a storage medium may reside as separate components.

Computer-readable media can include tangible and non-volatile computer-readable storage media.

For example, non-volatile computer-readable media may include random access memory (RAM), such as synchronization dynamic random access memory (SDRAM), read-only memory (ROM), or non-volatile random access memory (NVRAM). Read-only memory (EEPROM), flash memory, magnetic or optical data storage media, or other media that can be used to store instructions or data structures or Non-volatile computer readable media may also include combinations of the above.

Further, the methods described herein may be realized at least in part by computer-readable communication media that carry or carry code in the form of instructions or data structures and that can be accessed, read, and/or executed by a computer.

According to some embodiments of the present disclosure, a non-transitory computer-readable medium has one or more instructions stored thereon. The stored one or more instructions may be executed by a processor of the base station.

The stored one or more instructions cause the processors to: transmitting, to a Public Land Mobile Network (PLMN), a registration request message; receiving, from a specific network node of the PLMN, service information, based on the registration request message; and establishing a Packet Data Unit (PDU) session with the PLMN via an underlay network, based on the service information, wherein the registration request message includes capability information, wherein the capability information includes information that the UE supports information about available services based on the underlay network, wherein, based on the underlay network being a first network, the service information includes information that a first service is available, wherein, based on the underlay network being the first network, the PDU session is for the first service.

The present specification may have various effects.

For example, through the procedures disclosed herein, a terminal can receive, from an overlay network, only services permitted through the underlay network.

Effects that can be obtained through specific examples of the present specification are not limited to the effects listed above. For example, various technical effects that a person having ordinary skill in the related art can understand or derive from this specification may exist. Accordingly, the specific effects of the present specification are not limited to those explicitly described herein, and may include various effects that can be understood or derived from the technical characteristics of the present specification.

The claims described herein may be combined in various ways. For example, the technical features of the method claims of the present specification may be combined and implemented as an apparatus, and the technical features of the apparatus claims of the present specification may be combined and implemented as a method. In addition, the technical features of the method claim of the present specification and the technical features of the apparatus claim may be combined to be implemented as an apparatus, and the technical features of the method claim of the present specification and the technical features of the apparatus claim may be combined and implemented as a method. Other implementations are within the scope of the following claims.

1. A method comprising:
transmitting, by a User Equipment (UE) to a Public Land Mobile Network (PLMN), a registration request message;
receiving, by the UE from a specific network node of the PLMN, service information, based on the registration request message; and
establishing, by the UE, a Packet Data Unit (PDU) session with the PLMN via an underlay network, based on the service information,
wherein the registration request message includes capability information,
wherein the capability information includes information that the UE supports information about available services based on the underlay network,
wherein, based on the underlay network being a first network, the service information includes information that a first service is available,
wherein, based on the underlay network being the first network, the PDU session is for the first service.

2. The method of claim 1,
wherein the first network is a Standalone Non-Public Network (SNPN).

3. The method of claim 1,
wherein the specific network node is an Access and Mobility management Function (AMF),
wherein the step of receiving the service information is receiving a registration accept message including the service information.

4. The method of claim 1,
wherein the specific network node is a Policy Control Function (PCF),
wherein the step of receiving the service information is receiving a UE route selection policy (URSP) rule including the service information.

5. The method of claim 1, further comprising:
receiving, by the UE from the PLMN, the first service via the first network, based on the PDU session being established.

6. The method of claim 1,
wherein, based on the underlay network being the first network, the service information includes information that a second service is available,
wherein, based on the underlay network being the first network, the PDU session is for the second service.

7. The method of claim 1,
wherein, based on the underlay network being a second network, the service information includes information that a third service is available,
wherein, based on the underlay network being the second network, the PDU session is for the third service.

8. The method of claim 1,
wherein, based on the underlay network being the first network, a traffic related to the PDU session is through a User Plane Function (UPF) of the first network.

9. A method comprising:
receiving, by a PLMN from a UE, a registration request message;
transmitting, by the PLMN to the UE, service information, based on the registration request message; and
establishing, by the PLMN, a PDU session with the UE via an underlay network, based on the service information,
wherein the registration request message includes capability information,
wherein the capability information includes information that the UE supports information about available services based on the underlay network,
wherein, based on the underlay network being a first network, the service information includes information that a first service is available,
wherein, based on the underlay network being the first network, the PDU session is for the first service.

10. The method of claim 9,
wherein the first network is a SNPN.

11. The method of claim 9,
wherein the step of transmitting the service information is that an AMF of the PLMN transmits a registration accept message including the service information.

12. The method of claim 9,
wherein the step of transmitting the service information is that a PCF of the PLMN transmits an URSP rule including the service information.

13. The method of claim 9, further comprising:
providing, by the PLMN to the UE, the first service via the first network, based on the PDU session being established.

14. The method of claim 9,
wherein, based on the underlay network being the first network, the service information includes information that a second service is available,
wherein, based on the underlay network being the first network, the PDU session is for the second service.

15. The method of claim 9,
wherein, based on the underlay network being a second network, the service information includes information that a third service is available,
wherein, based on the underlay network being the second network, the PDU session is for the third service.

16. The method of claim 9,
wherein, based on the underlay network being the first network, a traffic related to the PDU session is through a UPF of the first network.

17. A UE, comprising:
at least one memory; and
at least one processor operably connectable to the at least one memory,
wherein the at least one memory stores instructions that, based on being executed by the at least one processor, cause the at least one processor to perform operations comprising:
transmitting, to a Public Land Mobile Network (PLMN), a registration request message;
receiving, from a specific network node of the PLMN, service information, based on the registration request message; and
establishing a Packet Data Unit (PDU) session with the PLMN via an underlay network, based on the service information,
wherein the registration request message includes capability information,
wherein the capability information includes information that the UE supports information about available services based on the underlay network,
wherein, based on the underlay network being a first network, the service information includes information that a first service is available,
wherein, based on the underlay network being the first network, the PDU session is for the first service.

18-20. (canceled)
